(19) United States
(12) Patent Application Publication
(10) Pub. No.: US 2007/0100924 A1
(43) Pub. Date: May 3, 2007

(54) Asynchronous signed multiplier and algorithm thereof

(76) Inventors: Chin-Yung Chen, Lung-Tan (TW); Kuang-Shyr Wu, Taoyuan Hsien (TW)

Correspondence Address: J.C. Patents, Inc., Suite 250, 4 Venture, Irvine, CA, 92618, US

(21) Appl. No.: 11/264,428

(22) Filed: Oct. 31, 2005

(51) Int. Cl. G06F 7/52

(52) U.S. Cl. 708/620

(57) ABSTRACT

An asynchronous signed multiplier including N pieces of partial product generators (PPGs), an operation module and a leading-zero-bit-detector is provided. The partial product generator generates a plurality of partial product values in response to a multiplier and a multiplicand. The operation module conducts a sum-up operation on the outputs from the (N-1)-th PPG to the first PPG, and the output from the N-th PPG is added in the end. In addition, as the leading-zero-bit-detector detects any leading-zero-bit in the multiplier or the multiplicand, the partial product outputs corresponding to the bit of “0” is directly set to zero.

### BACKGROUND OF THE INVENTION

1. Field of Invention

The present invention relates to a multiplier and an algorithm thereof, and particularly to an asynchronous signed multiplier and an algorithm thereof.

2. Description of the Related Art

The multiplier plays a significant role in many applications, such as in microprocessor, digital signal processing, discrete cosine transformation and so on. In fact, a multiplier consumes the most operation time in a chip for computation. Therefore, the multiplier running time determines the overall efficiency of a chip. So far, a number of approaches in the synchronous circuit design have been provided, and a few approaches in the asynchronous circuit design have also been proposed. In general, the asynchronous method has some advantages over the synchronous circuit, such as low power consumption, low average computation time, adaptability to different manufacturing process and environment. In particular, these advantages are vital to solve the problems encountered by some VLSIs (very large scale integrated circuits).

Today, the types of multipliers can be divided into a right-to-left (R-L) array multiplier, left-to-right (L-R) array multiplier, a partitioned array multiplier and a multiplexed array multiplier.

FIGS. 1A and 1B schematically illustrate a ripple-carry array multiplier 100 and a carry-save array multiplier 120, respectively, wherein both array multipliers have a 8×8 left-to-right (L-R) architecture. Referring to FIGS. 1A and 1B, the L-R multiplier 100 or 120 mainly includes partial product generators (PPGS) 102, L-R adder arrays 104 and a last-stage adder 108. The difference of a R-L multiplier from a L-R multiplier lies in the adder arrays 104 and the last-stage adder 108. In a R-L adder array 104, a sum-up operation begins with the least-significant-bit partial product (LSBPP) and then the sum and the carry will propagate stage by stage to the next higher significant-bit, until the last-stage adder where the most-significant-bit partial product (MSBPP) is added. Contrarily, in a L-R adder array, the sum-up operation begins with the most-significant-bit partial product (MSBPP) and the result will propagate stage by stage to the next lower significant-bit, until the last-stage adder where the least-significant-bit partial product (LSBPP) is added.

It known that either a bit of a multiplier or a multiplicand is 0, the corresponding partial product should be “0”. For a conventional multiplier, however, even on a “0” bit, the partial product operation is still redundantly implemented, which is time-wasting. Besides, for an operation member, the regular significant bit length thereof is much shorter than the designed bit length in a system. That is, the values of higher bits often are “0”, and computation on these 0 bits simply waste too much time.

FIG. 2 is a chart showing a statistic distribution of hit number of multipliers and multiplicands vs. effective-bit length. Referring to FIG. 2, the chart is a statistic from U.S. Pat. No. 6,746,853 data, where the maximum effective-bit of a data commonly is 16-bit. That is to say, the bit value of over 16-bit is almost all “0”. Thus, the statistic result proves there is a lot room to speed up the multiplication operation.

### SUMMARY OF THE INVENTION

Based on the above described, an object of the present invention is to provide an asynchronous signed multiplier having a faster multiplication operation.

Another object of the present invention is to provide an algorithm of asynchronous signed multiplication for computing signed data.

The asynchronous signed multiplier provided by the present invention is suitable for signed multiplication operation on a multiplier and a multiplicand, wherein the multiplier and the multiplicand have N-bit and M-bit, respectively. The N and M are positive integers larger than zero, and all of the multiplier, the multiplicand and the product are represented by 2's complement. The asynchronous signed multiplier of the present invention includes N pieces of partial product generators (PPGs) used for generating a partial product result according to a multiplier and a multiplicand, wherein the partial product is indicated by Dᵢ and Dᵢ represents in the i-th PPG a partial product obtained by means of timing every bit number of the multiplicand by a i-th bit number of the multiplier. Moreover, i is an integer smaller than or equal to N but larger than or equal to 1. Each partial product result includes M pieces of partial products and all output from the partial product generators are sent to an operation module to implement the following computation:

$${\sum }_{i = N - 1}^{1} {D}_{i}$$

From the computation, a first operation result is obtained. Afterwards, the operation module adds D_{N} to the first operation result for obtaining a second operation result. The operation module is further coupled to a leading-zero-bit-detector, which checks multipliers and multiplicands in a sequence bit-by-bit, from the MSB (most-significant-bit) to the LSB (least-significant-bit). During the checking, any “0” bit prior to the first “1” bit is counted as a void bit and the corresponding partial product value takes “0” for output. All bits from the first “1” bit to the LSB are called effective bits.

In the embodiment of the present invention, the asynchronous signed multiplier further includes a completion detector, coupled to the operation module for deciding the above-described second operation result.

On the other hand, the present invention provides an algorithm for the asynchronous signed multiplier, suitable for signed multiplication operation on a multiplier and a multiplicand, wherein the multiplier and the multiplicand have N-bit and M-bit, respectively. The N and M are positive integers larger than zero. The highest bit of the multiplier or the multiplicand is a sign bit. According to the present invention, the multiplicand is timed by each bit number of the multiplier sequentially from the i-th bit number to the first bit number for obtaining a plurality of first partial product values. Afterwards, the obtained first partial product values are summed up for obtaining a first operation result. Further, the multiplicand is timed by the N-th bit number of the multiplier for obtaining a plurality of second partial product values. The first operation result is then added by the second partial product values for obtaining a second operation result. For any “0” bit in the multiplier and multiplicand, the operation related to the “0” bit is exempted and the related partial produce value is directly set as “0”.

Since the partial product value related to the highest bit of the multiplier is scheduled in the end of the entire sum-up operation to add for the final sum, the present invention is capable of implementing operation on a signed number and saving computation time.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIGS. 1A and 1B schematically illustrate a ripple-carry array multiplier and a carry-save array multiplier, respectively, wherein both array multipliers have a 8×8 left-to-right (L-R) architecture.

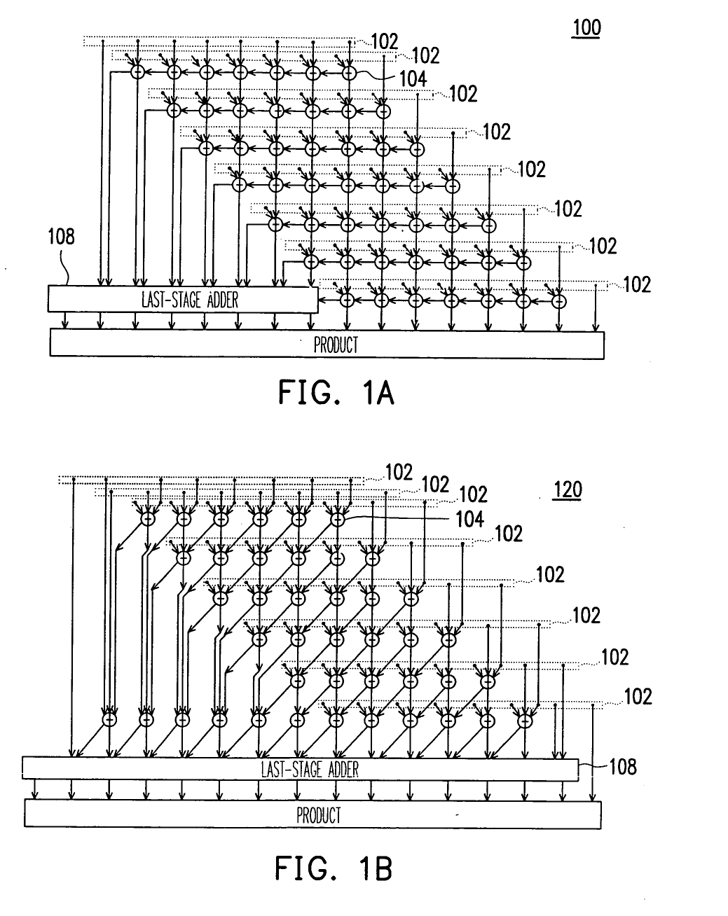

FIG. 2 is a chart showing a statistic distribution of hit number of multipliers and multiplicands vs. effective bit length.

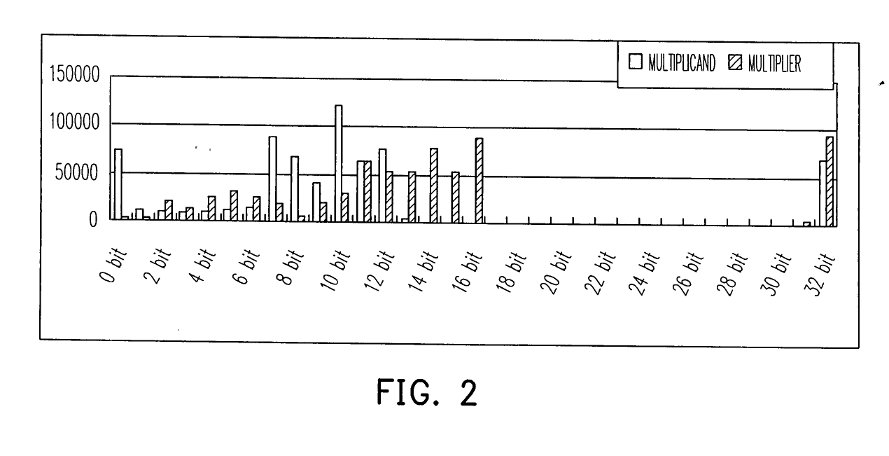

FIG. 3 is a diagram showing a regular multiplication operation of 5×5 left-to-right signed numbers.

FIG. 4 is a diagram showing a regular multiplication operation of 5×5 left-to-right signed numbers according to an embodiment of the present invention.

FIG. 5 is a schematic circuit drawing of an asynchronous signed multiplier according to an embodiment of the present invention.

FIG. 6 is a partially enlarged diagram showing the interconnection between the first adder and the multiplexer of the operation module in FIG. 5.

### DESCRIPTION OF THE EMBODIMENTS

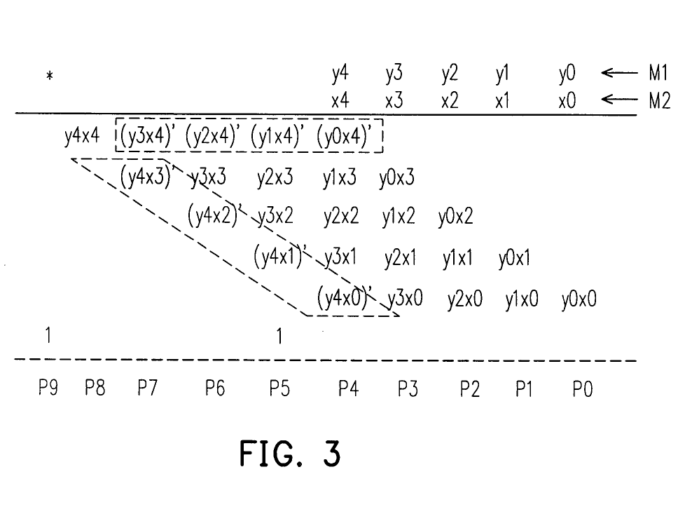

FIG. 3 is a diagram showing a regular multiplication operation of 5×5 left-to-right signed numbers. Referring to FIG. 3, wherein M1 and M2 indicate a multiplicand and a multiplier, it is assumed the higher bits of the multiplier M2, for example, x4, x3 and x2 are “0”, thus the partial product values related the “0” bits are “0” regardless of the value of the multiplicand M1. According to the common knowledge, the operation related to the “0” bit is exempted for saving time and the related partial produce value is directly set as “0”.

However, for signed numbers of multiplicand M1 and multiplier M2, the situation is different from the above described, wherein the highest bits of multiplicand M1 and multiplier M2, y4 and x4, are sign bits. It can be seen from FIG. 3, for a multiplication operation on signed numbers, except for the partial product (y4x4) related to both the highest bits of multiplicand M1 and multiplier M2, the remaining partial products related to one of the highest bits of multiplicand M1/multiplier M2 need to be phase-inverted, as shown in the area framed by the broken line. Hence, the original “0” partial products turn to “1” after phase-inverting.

In addition, it can be seen further that the effective bit length is usually not long, so that it is highly possibly for the partial product values of the first row, for example in FIG. 3, y4x4, (y3x4)′, (y2x4)′, (y1x4)′ and (y0x4)′, to be “1” and therefore the addition computations on the succeeding partial values are continuously conducted regardless of whether the following partial values are “0” or not. It unnecessarily wastes a lot of time.

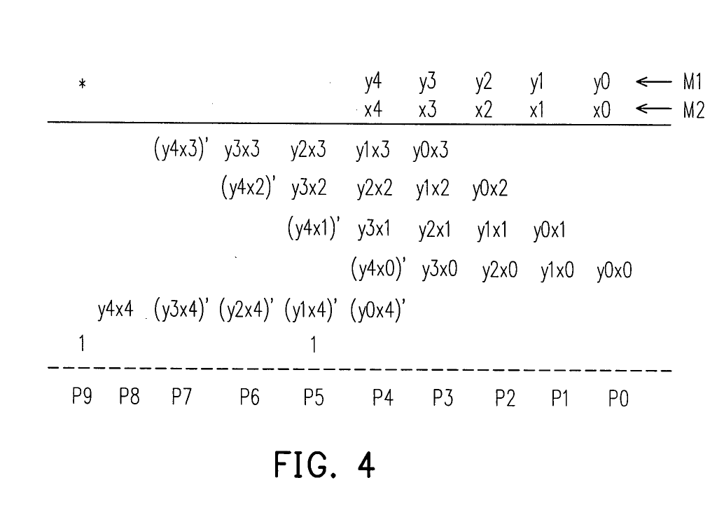

To resolve the above-described problem, the present invention provides, for example, a 5×5 L-R signed multiplication algorithm as shown in FIG. 4. In reverse thinking, the present invention rearranges the partial product values of the original first row in FIG. 3 to the last stage for computation. As a result, the partial product values of the original second row in FIG. 3, i.e. (y4x3)′, y3x3, y2x3, y1x3 and y0x3, are advanced to the first row for computation. Under the novel rearrangement, once a higher bit of multiplicand M1 or multiplier M2 is found as “0”, the related partial product value can be flagged as a zero without computation. Even though some partial product values related to the highest bit turn to “1” after phase-inverting, the actual computation time is still saved, because those inverted partial product values are scheduled in the end for computation already.

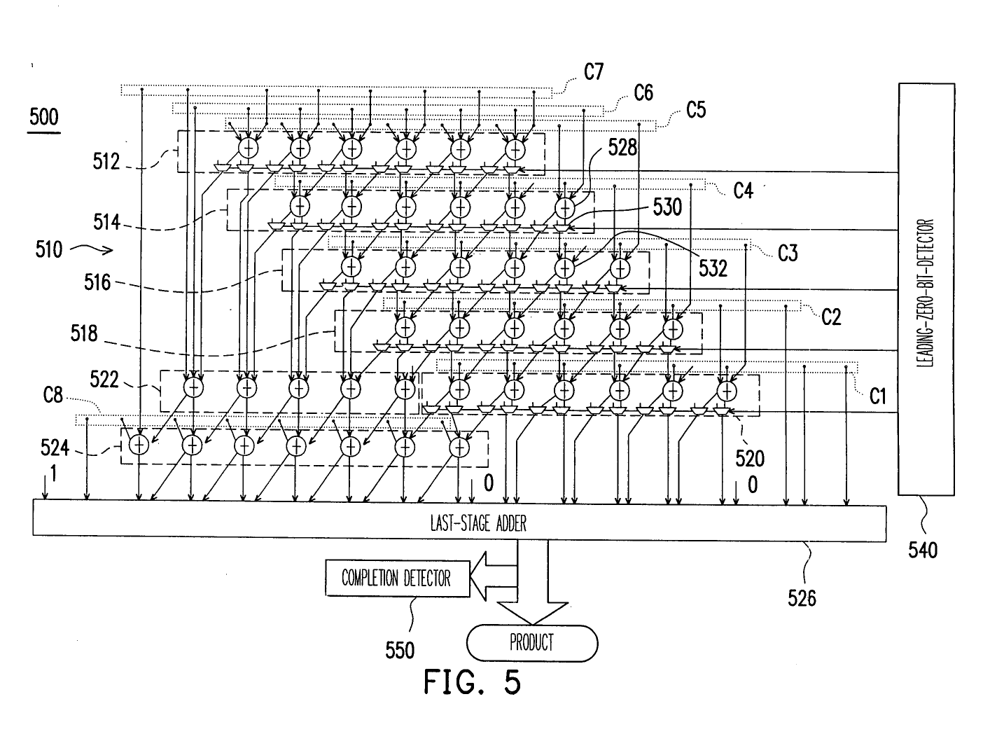

FIG. 5 is a schematic circuit drawing of an asynchronous signed multiplier according to an embodiment of the present invention. Referring to FIG. 5, a multiplier 500 provided by the embodiment is an 8×8 multiplier, which means it can serve for a multiplication operation on a signed 8-bit multiplier and a signed 8-bit multiplicand. The 8×8 multiplier 500 of the embodiment is only exemplary to explain the present inventiony, not to limit the scope of the present invention. As the above mentioned, the asynchronous signed multiplier provided by the present invention is designed for handling a multiplication operation on a N-bit multiplier and a M-bit multiplicand, where N and M are positive integers larger than 0. In fact, for those skilled in the art, it is easy to construct a desired multiplier with other specification based on the principle of the present invention without departing from the spirit of the invention.

The multiplier 500 includes a plurality of partial product generators (PPGs) C1˜C8. In the present invention, the PPG number is specified as the same as the bit number of the multiplier. The multiplier 500 further includes an operation module 510, a leading-zero-bit-detector 540 and a completion detector 550.

Referring to FIG. 5, the PPGs C1˜C8 would generate a partial product result in response to a multiplier and a multiplicand and the partial product result generated by the i-th PPG is indicated by Dᵢ, wherein the subscript i represents the i-th PPG implements multiplication on all bits of a multiplicand and the i-th bit of a multiplier. For example, D3 means the partial product result from the third PPG C3, wherein all bits of a multiplicand is timed by the 3-rd bit of a multiplier. Each partial product result has a plurality of partial product values and each partial product value in a PPG is marked by symbol “●”

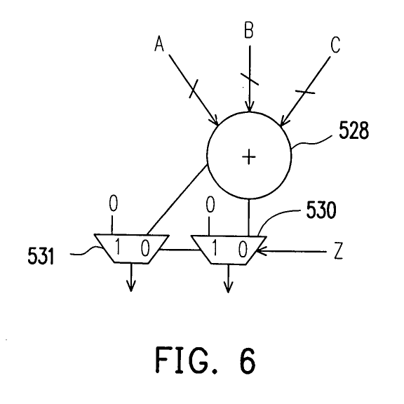

The operation module 510 includes adder modules 512, 514, 516, 518 and 520. Each adder module includes a plurality of first adders and a plurality of multiplexers, for example, a first adder 528 and a multiplexer 530. Wherein, each first adder receives the output from a corresponding PPG; that is the corresponding partial product values. For example, the first adder 528 receives a first partial product value from the PPG C1. Besides, each multiplexer has a first input end and a second input end. Wherein, the first input end of the multiplexer receives the output from a corresponding adder, while the second input end receives a constant of “0” (as shown in FIG. 6). The output from each multiplexer is sent to the next-stage adder module. For example, one of the input ends of the multiplexer 530 receives the output from the first adder 528, while another input end thereof receives a constant of “0” and the output from the first adder 528 is sent to the first adder 532 in the next-stage adder module 516.

FIG. 6 is a partially enlarged diagram showing the interconnection between the first adder and the multiplexer of the operation module in FIG. 5. Referring to FIG. 6, taking the first adder 528 as an example, the first adder 528 in the embodiment has three input ends A, B and C for receiving partial product values or/and the output from the last-stage operation module, respectively. The first adder 528 has a sum-up output end and a carry output end, wherein the sum-up output end is used for outputting the sum of the values received by the input ends A, B and C. In addition, as the first adder 528 generates a carry, the carry value will be output from the carry output end.

One of the input ends in the multiplexer 530 and one of input ends in the multiplexer 531 receive the output from the sum-up output end and the output from the carry output end of the first adder 528, respectively. Another ends of the multiplexers 530 and 531 receive constants of “0”. The multiplexers 530 and 531 have one more end, a selection end Z, respectively. The selection end Z is coupled to, for example, the leading-zero-bit-detector 540 in FIG. 5. In this way, the leading-zero-bit-detector 540 is able to control and switch the output from the multiplexer 531.

Referring to FIG. 5 again, the operation module 510 further includes a second adder module 522, a third adder module 524 and a last-stage adder 526. Wherein, the second adder module 522 includes a plurality of second adders for receiving the outputs from a part of the multiplexers in the adder modules 512, 514, 516, 518 and 520. In the present invention, the second adder module 522 and the partial product generators (PPGs) C1˜C7 conduct a following computation on the seven outputs, i.e. (N-1) outputs, from the PPG C1 to the PPG C7 for obtaining a first operation result:

$${\sum }_{i = N - 1}^{1} {D}_{i} \qquad ( 1 )$$

wherein N is equal to 8 in the embodiment.

As the adder modules 512, 514, 516, 518, 520 and the second adder module 522 conduct a computation of the formula (1), if the leading-zero-bit-detector 540 finds a leading-zero-bit either in the multiplier or the multiplicand, all the related outputs of partial products are set to “0”. In the embodiment, if the leading-zero-bit-detector 540 detects a leading-zero-bit either in the multiplier or the multiplicand, a control signal is generated and sent to the selection end Z of the multiplexers, so that the multiplexers directly output constants “0” without any operation of the first adder.

The third adder module 524 also includes a plurality of third adders, which receive the partial product values generated by the eighth, i.e. N-th, PPG C8, respectively. The third adder module 524 and the last-stage adder 526 will add D₈ to the first operation value, i.e. adding the first operation value to the partial product result generated by the PPG C8, to obtain a second operation value. The second operation value is just the final product value by a multiplication operation on the multiplier and the multiplicand.

In the embodiment, The output from the last-stage adder 526 needs to be sent to the completion detector 550 to complete a detection on the second operation value by using the completion detector 550.

From the above described, it can be seen that the present invention puts back the partial products of the N-th bit in a multiplier for computation at the last stage, therefore the present invention still can save the operation time when conducting a signed multiplication.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An asynchronous signed multiplier, for conducting signed multiplication operation on a multiplier and a multiplicand, wherein the multiplier and the multiplicand has N-bit and M-bit, respectively, N and M are positive integers larger than zero and the multiplier and the multiplicand are signed numbers; the asynchronous signed multiplier comprising:
N pieces of partial product generator (PPG), used for generating a partial product result in response to the multiplier and the multiplicand, respectively, wherein the partial product result is indicated by Dᵢ, Di represents the partial product result by timing every bit number of the multiplicand by the i-th bit number of the multiplier in the i-th PPG, i is an integer smaller than and equal to N but larger than and equal to 1 and each partial product result has M pieces of partial product values;
an operation module, receiving the outputs from the PPGs and used for conducting the following operation:
$${\sum }_{i = N - 1}^{1} {D}_{i}$$
and obtaining a first operation result, followed by adding D_{N} to the first operation result with the operation module to obtain a second operation result; and
a leading-zero-bit-detector, coupled to the operation module, wherein as the leading-zero-bit-detector detects a leading-zero-bit either in the multiplier or the multiplicand, all the partial product value outputs corresponding to the detected “0” bit are set to “0” without any operation on the zero-bit.

2. The asynchronous signed multiplier as recited in claim 1, further comprising a completion detector coupled to the operation module for checking the second operation result.

3. The asynchronous signed multiplier as recited in claim 1, wherein the operation module further comprises:
a plurality of first adders, receiving the corresponding partial product values, respectively, for sequentially accumulating the outputs from the (N-1)-th PPG, the (N-2)-th PPG until the first PPG;
a plurality of multiplexers, each having a first input end, a second input end and an output end, wherein the first input end of each multiplexer receives the output from a corresponding first adders, respectively, the second input end of each the multiplexer receives a constant of “0”, the multiplexers select the first input end or the second input end thereof to couple to the output end thereof according to the output from the leading-zero-bit-detector and the multiplexers send the data of the first input end or the second input end thereof to the first adder coupled by the next-stage PPG;
a plurality of second adder, receiving the outputs from a part of the multiplexers, respectively;
a plurality of third adder, receiving the outputs from the N-th PPG and the first PPG; and
a last-stage adder, receiving the outputs from the multiplexers handling the operations relating to the outputs from the first PPG for computing the second operation value.

4. An algorithm for asynchronous signed multiplication, suitable for conducting signed multiplication operation on a multiplier and a multiplicand, wherein the multiplier is a N-bit number, N is a positive integer larger than zero and the highest bit of the multiplier and the multiplicand is a sign bit; the algorithm comprising the following steps:
timing the multiplicand by a plurality of bit numbers, sequentially from the (N-1)-th bit number to the first bit number, for obtaining a plurality of first partial product values;
summing up the first partial product values for obtaining a first operation result;
timing the multiplicand by the N-th bit number of the multiplier for obtaining a plurality of second partial product values;
adding the second partial product values to the first sum value for obtaining a second operation result; and
if a leading-zero-bit in the multiplier or the multiplicand is detected directly setting the partial product values relating the bit of “0” to zero without conducting any operation on the bit of “0“.

5. The algorithm for asynchronous signed multiplication as recited in claim 4, further comprising a operation of phase-inverting the partial product values relating the highest bit of the multiplier or relating the highest bit of the multiplicand, except for the partial product values between the highest bit of the multiplier and the highest bit of the multiplicand.
